(19) United States
(12) Patent Application Publication
(10) Pub. No.: US 2026/0154893 A1
(43) Pub. Date: Jun. 4, 2026

(54) EFFECT PROCESSING METHOD, ELECTRONIC DEVICE, AND STORAGE MEDIUM

(71) Applicant: Beijing Zitiao Network Technology Co., Ltd., Beijing (CN)

(72) Inventors: Ruitian YANG, Beijing (CN); Jiacheng LIU, Beijing (CN); Shichen PENG, Beijing (CN); Xiaofeng LI, Beijing (CN)

(21) Appl. No.: 19/409,258

(22) Filed: Dec. 4, 2025

(30) Foreign Application Priority Data
Dec. 4, 2024 (CN) 202411775438.7

(51) Int. Cl. G06T 13/80; G06T 7/194; G06T 11/60

(52) U.S. Cl. CPC G06T 13/80; G06T 7/194; G06T 11/60; G06T 2207/10016; G06T 2207/20081

(57) ABSTRACT

An effect processing method, an electronic device, and a storage medium are provided. The method includes: obtaining a first image in response to an effect processing request, where the first image includes a first foreground object; and performing effect processing on the first image to obtain a first video and displaying the first video, where the first video includes a first foreground image of the first image, the first foreground image includes the first foreground object, and at least a part of an object area of the first foreground object is presented in a preset style.

### CROSS-REFERENCE TO RELATED APPLICATION(S)

The present application claims priority to Chinese Patent Application No. 202411775438.7, filed on Dec. 4, 2024, which is incorporated herein by reference in its entirety as a part of the present application.

### TECHNICAL FIELD

Embodiments of the present disclosure relate to the field of computer processing technologies.

### BACKGROUND

In image processing or video production scenarios, the application of effects is highly favored by users. Images or videos are processed using the selected effects, so that presentation effects of the images or videos are enriched.

In related technologies, adding effects to images typically refers to adding preset effect elements (e.g., stickers) into the images to enable the images to present the effects. However, this effect processing method results in a rather monotonous effect presentation of the images, which impacts the user experience when using effects.

### SUMMARY

Embodiments of the present disclosure provide an effect processing method, which includes:
obtaining an image to be processed (for example, a first image) in response to an effect processing request, where the image to be processed includes a target foreground object (for example, a first foreground object); and
performing effect processing on the image to be processed to obtain a target effect video (for example, a first video) and displaying the target effect video; where the target effect video includes a target foreground image (for example, a first foreground image) of the image to be processed; the target foreground image includes the target foreground object, and at least a part of an object area of the target foreground object is presented in a preset style.

Embodiments of the present disclosure further provide an effect processing apparatus, which includes:
an effect processing request module, configured to, obtain an image to be processed in response to an effect processing request, where the image to be processed includes a target foreground object; and
an effect video display module, configured to perform effect processing on the image to be processed to obtain a target effect video and display the target effect video; where the target effect video includes a target foreground image of the image to be processed; the target foreground image includes the target foreground object, and at least a part of an object area of the target foreground object is presented in a preset style.

Embodiment of the present disclosure further provide an electronic device, which includes:
one or more processors; and
a storage apparatus for storing one or more programs;
when the one or more programs are executed by the one or more processors, causing the one or more processors to implement the effect processing method according to any one of the embodiments of the present disclosure.

Embodiments of the present disclosure further provide a storage medium including computer-executable instructions, where the computer-executable instructions, when executed by a computer processor, are used for executing the effect processing method according to any one of the embodiments of the present disclosure.

Embodiments of the present disclosure further provide a computer program product including a computer program/instruction, and when executed by a processor, the computer program/instruction implementing the effect processing method according to any one of the embodiments of the present disclosure.

### BRIEF DESCRIPTION OF DRAWINGS

The above and other features, advantages, and aspects of the embodiments of the present disclosure will become more apparent with reference to the accompanying drawings and the following specific implementations. Throughout the accompanying drawings, identical or similar reference numerals represent identical or similar elements. It should be understood that the accompanying drawings are schematic and that devices and elements are not necessarily drawn to scale.

FIG. 1 is a schematic flowchart of an effect processing method according to an embodiment of the present disclosure;

FIG. 2 is a schematic flowchart of another effect processing method according to an embodiment of the present disclosure;

FIG. 3 is a schematic flowchart of another effect processing method according to an embodiment of the present disclosure;

FIG. 4 is a schematic flowchart of another effect processing method according to an embodiment of the present disclosure;

FIG. 5 is a schematic diagram of an interface display for an effect editing process according to an embodiment of the present disclosure;

FIG. 6 is a schematic flowchart of an effect processing method according to an embodiment of the present disclosure;

FIG. 7 is a schematic diagram of a structure of an effect processing apparatus according to an embodiment of the present disclosure; and

FIG. 8 is a schematic diagram of a structure of an electronic device according to an embodiment of the present disclosure, for implementing embodiments of the present disclosure.

### DETAILED DESCRIPTION

Embodiments of the present disclosure will be described in more detail below with reference to the accompanying drawings. Although some embodiments of the present disclosure are shown in the accompanying drawings, it should be understood, however, that the present disclosure may be implemented in various forms and should not be construed as being limited to the embodiments set forth herein, but rather are provided for a more thorough and complete understanding of the present disclosure. It should be understood that the accompanying drawings and embodiments of the present disclosure are for exemplary purposes only and are not intended to limit the scope of protection of the present disclosure.

It should be understood that the various steps described in the method embodiments of the present disclosure may be performed in a different order, and/or in parallel. In addition, the method embodiments may include additional steps and/or omit performing the illustrated steps. The scope of the present disclosure is not limited in this regard.

The term “include” and its variants as used herein mean open-ended inclusion, i.e., “including but not limited to”. The term “based on” is “based at least in part on”. The term “one embodiment” means “at least one embodiment”; the term “another embodiment” means “at least one additional embodiment”; and the term “some embodiments” means “at least some embodiments”. Relevant definitions of other terms will be given in the description below.

It should be noted that the concepts of “first”, “second” and the like mentioned in the present disclosure are only used to differentiate different apparatuses, modules or units, and are not used to limit the order or interdependent relationships of functions performed by these apparatuses, modules or units.

It should be noted that the modifications of “one” and “a plurality of” mentioned in the present disclosure are schematic rather than limiting, and persons skilled in the art should understand that, unless otherwise expressly stated in the context, they should be understood as “one or more”.

The names of messages or information interacted between a plurality of apparatuses in the embodiments of the present disclosure are used for illustrative purposes only and are not intended to limit the scope of those messages or information.

It can be understood that before using the technical solution disclosed in each embodiment of the present disclosure, the user should be informed of the type of personal information involved in the present disclosure, the scope of application, the use scenarios, etc., in accordance with the associated laws and regulations and obtain the user authorization in an appropriate manner.

For example, in response to receiving an active request from a user, a prompt message is sent to the user to explicitly prompt the user that the requested operation will require access to and use of the user's personal information. Thus, the user is allowed to independently choose whether or not to provide the personal information to software or hardware, such as an electronic device, an application program, a server, or a storage medium, that performs operations of the technical solution of the present disclosure based on the prompt message.

As an optional but non-limiting implementation, in response to receiving the active request from the user, the manner of sending the prompt message to the user may be, for example, a pop-up window, in which the prompt message may be presented in the form of text. In addition, the pop-up window may contain an option control for the user to select “agree” or “disagree” to provide the personal information to the electronic device.

It can be understood that the above notification and user authorization process is only schematic and does not limit the implementation of the present disclosure, and other methods that satisfy the associated laws and regulations may also be used in the implementation of the present disclosure.

It can be understood that data (including but not limited to the data itself, the acquisition or use of the data) involved in the technical solutions shall comply with the requirements of relevant laws, regulations, and related provisions.

FIG. 1 is a schematic flowchart of an effect processing method according to an embodiment of the present disclosure. The embodiment disclosed herein is applicable to scenarios in which effects are applied to the obtained images to be processed. The method may be performed by an effect processing apparatus. The effect processing apparatus may be implemented in the form of software and/or hardware, and optionally, by an electronic device. The electronic device may be a mobile terminal, a PC, a server, or the like. As shown in FIG. 1, the method of this embodiment may specifically include S110 and S120.

S110: obtaining an image to be processed in response to an effect processing request, where the image to be processed includes a target foreground object.

The effect processing request may be understood as an instruction for performing effect processing on the image. The effect processing request may be generated in various ways. Optionally, the effect processing request may be generated when a trigger operation for a preset effect processing control is detected, or when trigger words associated with effect processing are detected in the received audio information, or when an effect processing instruction is detected in the received instruction. The image to be processed may be an image to be subjected to effect processing. Optionally, the image to be processed may be a default template image, an image captured by a camera disposed on a terminal, an image obtained from a target storage space (e.g., an application software image library or local terminal photo album) in response to a user's trigger operation, or an image received from an external device. In the embodiment of the present disclosure, the image to be processed includes a target foreground object. The target foreground object may be understood as an object determined by detecting the image to be processed using a preset foreground object detection algorithm. In other words, objects included in the foreground image of the image to be processed may be used as the target foreground objects. It should be noted that all objects included in the foreground image of the image to be processed may be used as the target foreground objects; or, at least one object may be selected from all objects included in the foreground image of the image to be processed based on preset object selection logics, and the selected at least one object may be used as the target foreground object. The target foreground object may be an object of any type, optionally including a person, an animal, a building, or a preset item, etc.

It should be noted that when the image to be processed includes the target foreground object, it indicates that the image to be processed may include a foreground image. In the embodiment of the present disclosure, the image to be processed may include only a foreground image; or, the image to be processed may include both a foreground image and a background image. The background image may be any type of background image, optionally, it may be an original background image captured at the same time as the foreground image; or, it may also be a preset background image, such as a pure white background, a pure black background, or a background image extracted from another image.

As an optional implementation of the embodiments of the present disclosure, the effect processing request may be generated when a control trigger operation for a preset effect processing control is detected. Further, in response to the effect processing request, an image display interface is displayed, which includes at least one candidate image. Further, when an image selection operation for the candidate image is detected, the selected candidate image may be determined based on the image selection operation, and the selected candidate image is used as the image to be processed. Further, an object included in the foreground image of the image to be processed may be used as the target foreground object.

S120: performing effect processing on the image to be processed to obtain a target effect video and displaying the target effect video; where the target effect video includes a target foreground image of the image to be processed; the target foreground image includes the target foreground object, and at least a part of an object area of the target foreground object is presented in a preset style.

The target effect video may be an effect video used for presenting an effect processing result of the image to be processed. The target effect video includes a target foreground image of the image to be processed; and the target foreground image includes the target foreground object, and at least a part of the object area of the target foreground object is presented in a preset style. The target foreground image may be a foreground image in an effect image obtained after the image to be processed is subjected to the effect processing. At least a part of the object area of the target foreground object included in the target foreground image is presented in a preset style. The at least a part of the object area may be the entire object area and/or a part of the object area of the target foreground object. For example, when the target foreground object is a person, at least a part of the object area may be a display area of the person's accessories and/or clothing; when the target foreground image is an animal, at least a part of the object area may be a display area of the animal's fur; when the target foreground image is a preset item, at least a part of the object area may be the entire object area of the preset item. The preset style may be a stylized effect used when the target foreground object is subjected to stylization processing. The preset style may be any style, optionally including a “plush” style, a cartoon style, a retro style, or a cyber style, etc. The “plush” style may be understood as a target foreground object being presented in an image with a texture similar to that of a plush toy.

In the embodiment of the present disclosure, in response to obtaining a target image to be processed, the target image may be subject to effect processing to obtain a target foreground image. Further, the target effect video may be determined based on the target foreground image and then displayed. There are various methods to determine the target foreground image. Optionally, the method may include processing the image to be processed using a stylization processing model to obtain the target foreground image; or stylizing the target foreground image in the image to be processed using a stylization processing algorithm corresponding to the preset style, and generating the target foreground image based on the target foreground image presented in the preset style, etc.

It should be noted that, in the embodiment of the present disclosure, the target effect video may be an effect video that presents the target foreground image as the video foreground information and that presents any background information as the video background information; or, the target effect video may present the target foreground image as the video foreground information and presents the video background image as the video background information. The video background image may include at least one of the image to be processed, the target background image (for example, a first background image) of the image to be processed, and the preset background image.

Optionally, when the target effect video presents the target foreground image as the video foreground information and presents any background information as the video background information, and after the image to be processed is obtained, the image to be processed may be subjected to effect processing to obtain the target foreground image, where at least a part of the object area of the target foreground object in the target foreground image is presented in a preset style. Further, the target effect video may be determined based on the target foreground image and the preset video background information.

Optionally, when the target effect video presents the target foreground image as the video foreground information and presents the video background image as the video background information, and after the image to be processed is obtained, the image to be processed may be subjected to effect processing to obtain the target foreground image and the video background image. Further, the target effect video may be generated based on the target foreground image and the video background image.

In the embodiment of the present disclosure, the target effect video may be an effect video generated based on a single image to be processed, or an effect video generated based on a plurality of images to be processed.

Optionally, performing effect processing on the image to be processed to obtain a target effect video includes: in response to the presence of a single image to be processed, determining an image effect video corresponding to the image to be processed, and using the determined image effect video as the target effect video.

Here, the image effect video may be understood as an effect animation determined based on the image to be processed.

As an optional implementation of the embodiments of the present disclosure, in response to the image to be processed being a single image, the image to be processed may be subjected to effect processing to obtain the target foreground image. Further, the image effect video may be determined based on the target foreground image, and the image effect video may be used as the target effect video.

Optionally, performing effect processing on the image to be processed to obtain a target effect video includes: in response to the presence of a plurality of images to be processed, determining an image effect video corresponding to each of the images to be processed, and determining a target effect video based on the image effect videos corresponding to the plurality images to be processed.

As another optional implementation of the embodiment of the present disclosure, in response to the image to be processed being a plurality of images to be processed, effect processing may be performed on each of the plurality of images to be processed to obtain a plurality of target foreground images. Further, each of the plurality of target foreground images may be processed to obtain image effect videos corresponding to the plurality of images to be processed. Further, a plurality of image effect videos may be spliced together according to a preset video splicing order, and a spliced effect video may be used as the target effect video. The video splicing order may include the order in which the images to be processed is obtained, the order in which the image effect videos are determined, a random splicing order, or other preset orders. Such a setting has the advantages of achieving the effect of splicing a plurality of image effect videos corresponding to a plurality of images to be processed into a target effect video, enabling effect processing to the plurality of images to be processed to obtain the target effect video, enriching methods for determining the target effect video and enhancing the flexibility of the effect processing method.

In the embodiment of the present disclosure, the target effect video may be a static effect displaying video or a dynamic effect displaying video. When the target effect video displays a static effect, images included in the target effect video are displayed with the static effect. When the target effect video displays a dynamic effect, images included in the target effect video are displayed with an animation effect.

Optionally, when the target effect video includes a target foreground image, the target foreground image is displayed with a first animation effect; when the target effect video includes a target background image of the image to be processed, the target foreground image is displayed with the first animation effect, the target background image is displayed with a second animation effect; when the target effect video includes the image to be processed and the target background image of the image to be processed, the target foreground image is displayed with the first animation effect, the target background image is displayed with the second animation effect, and the image to be processed is displayed with a third animation effect. Such a setting has the advantages of achieving the effect of displaying all images included in the target effect video with their corresponding animation effects, enabling layer-based effect processing to the image to be processed, to obtain the target effect video, and enriching the effect display of the target effect video.

The first animation effect may be any animation effect, and optionally, it may be an animation effect of camera movement changes (e.g., the target foreground object changing from small to large or from large to small) or an animation effect of the target foreground object swaying in the target effect video. The target background image may be a background image from the effect image obtained after the image to be processed is subjected to the effect processing. The second animation effect may be any animation effect, and optionally, it may be an animation effect of camera movement changes (e.g., the target background image changing from small to large or from large to small) or an animation effect of the target background image swaying in the target effect video. The third animation effect may be any animation effect, and optionally, it may be an animation effect of camera movement changes, or an animation effect of the image to be processed swaying in the target effect video, etc.

It should be noted that when the target effect video includes the target background image of the image to be processed, the first animation effect and the second animation effect may be the same animation effects, or may be different animation effects. When the target effect video includes the image to be processed and the target background image of the image to be processed, the first animation effect, the second animation effect, and the third animation effect may be the same animation effects or different animation effects, for example, the first animation effect, the second animation effect, and the third animation effect are all different, or, two of the first animation effect, the second animation effect, and the third animation effect are different.

According to the technical solution of the present disclosure, an image to be processed is obtained in response to an effect processing request, the obtaining of the image to be processed may be triggered by a single interactive operation, and the image to be processed includes a target foreground object, providing a data foundation for subsequent effect processing of the foreground object in the image. Further, effect processing is performed on the image to be processed to obtain a target effect video and then the target effect video is displayed; where the target effect video includes a target foreground image of the image to be processed; the target foreground image includes the target foreground object, and at least a part of the object area of the target foreground object is presented in a preset style. In this way, the problem that the presentation of effects in related technologies is rather monotonous and lacks interest is solved ; during the effect processing, the target foreground object can be identified automatically and extracted from the image to be processed, and the target foreground object can be stylized to obtain a stylized target foreground image, so as to generate the target effect video containing the target foreground image, thereby achieving differentiated processing of the target foreground object in the image to be processed, enriching the effect processing methods, enhancing the content depth of the image after effect processing, and improving the effect interaction experience.

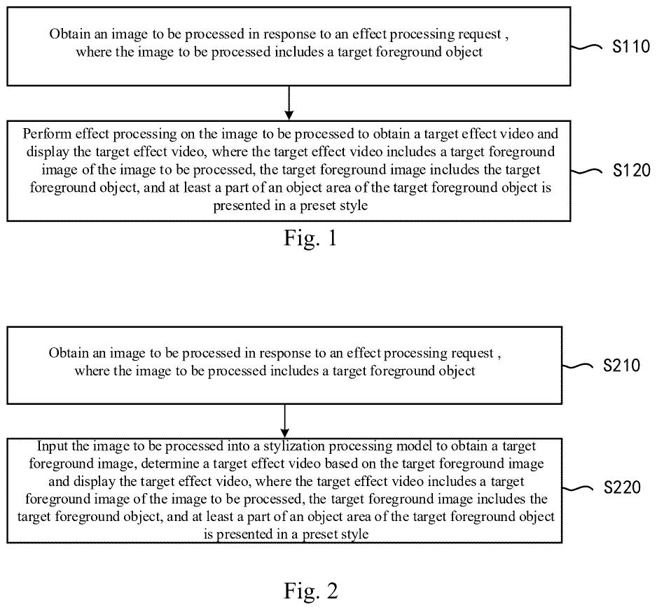

FIG. 2 is a schematic flowchart of another effect processing method according to an embodiment of the present disclosure. The technical solution of this embodiment is based on the above embodiment, in which the target foreground image is presented as video foreground information in the target effect video, and the process of determining the target effect video is further refined. Optionally, performing effect processing on the image to be processed to obtain a target effect video includes: inputting the image to be processed into a stylization processing model to obtain a target foreground image, and determining a target effect video based on the target foreground image. The specific implementation may refer to the description of this embodiment. Technical features that are the same or similar to the foregoing embodiments will not be repeated herein. As shown in FIG. 2, the method of this embodiment may specifically include the following steps.

S210: obtaining an image to be processed in response to an effect processing request, where the image to be processed includes a target foreground object.

S220: inputting the image to be processed into a stylization processing model to obtain a target foreground image, determining a target effect video based on the target foreground image and displaying the target effect video; where the target effect video includes a target foreground image of the image to be processed; the target foreground image includes the target foreground object, and at least a part of an object area of the target foreground object is presented in a preset style.

The video foreground information typically refers to display information that is prominently located within a video frame and presents an animation effect. Generally speaking, the foreground object is typically an object that is not obscured within the image to be processed. The video foreground information is generally displayed in an upper layer of the video frame. The stylization processing model is a neural network model that takes an image as an input object, performs stylization processing on the image, and outputs an image with a specific stylized effect. The stylization processing model may be configured to extract an image foreground object and convert the image foreground object into a preset style to generate a desired foreground image. The stylization processing model may be a deep learning model with any structural architecture.

In the embodiment of the present disclosure, the stylization processing model is obtained by training a first deep learning model based on a first sample image and the desired foreground image. Before applying the stylization processing model provided in the embodiment of the present disclosure, the prebuilt first deep learning model may be trained using a supervised or unsupervised method. Before training the model, a plurality of training samples may be built to train the model based on the plurality of training samples. Optionally, the training process of the stylization processing model may include: obtaining a plurality of training samples, where the training samples include the first sample image and the desired foreground image; for each of the training samples, inputting the first sample image from the training sample into the prebuilt first deep learning model to perform object extraction on a sample foreground object in the first sample image based on the first deep learning model, converting the sample foreground object into a preset style to generate an actual foreground image, and outputting the actual foreground image; determining a loss value based on the actual foreground image and the desired foreground image in the training sample; based on the loss value, modifying model parameters in the first deep learning model, and taking the convergence of a loss function in the first deep learning model as a training objective, so that the trained first deep learning model is used as the stylization processing model. The first sample image may be an image including the sample foreground object. The desired foreground image includes the sample foreground object in the first sample image, and the sample foreground object is presented in the preset style.

In the embodiment of the present disclosure, after the image to be processed is obtained, the image to be processed may be input into the stylization processing model. Further, the target foreground object in the image to be processed may be extracted based on the stylization processing model, the target foreground object may be converted into a preset style, and the target foreground image may be generated. Thereafter, the target foreground image may be output. Further, the target effect video may be determined based on the target foreground image and then displayed.

It should be noted that when the target foreground image is presented as video foreground information in the target effect video, the video background information of the target effect video may be any form of background information, and the embodiments of the present disclosure do not impose specific limitations on the video background information of the target effect video.

It should also be noted that there are various methods to determine the target effect video based on the target foreground image. Optionally, the target foreground image is displayed based on a preset display duration and/or display form, and the resulting video is used as the target effect video; or, at least one foreground-generated image is generated based on the target foreground image, the target foreground image and at least one foreground-generated image are displayed based on the preset display duration and/or display form, and the displayed video is taken as the target effect video; or, the target foreground image is processed based on an animation video corresponding to the target foreground image to obtain the target effect video, etc.

Optionally, determining a target effect video based on the target foreground image includes: determining first animation data corresponding to the target foreground image, determining a video foreground animation based on the target foreground image and the first animation data, and determining a target effect video based on the video foreground animation. Such a setting has the advantages of enabling the target foreground image to be presented with an animation effect, further enriching the video foreground information of the target effect video and improving the presentation effect of the video foreground information.

The first animation data may be understood as data that enables an image and/or video it acts upon to be presented with a preset animation effect. In the embodiment of the present disclosure, the first animation data may be animation data corresponding to the target foreground image, i.e., the first animation data is pre-determined animation data applied to the target foreground image. The video foreground animation may be understood as animation elements and/or dynamic effects in the foreground portion of a video frame. For example, the first animation data may be combined animation data of an appearance animation and camera movement changes. Further, the video foreground animation may be the target foreground object appearing in the frame in a preset style corresponding to the appearance animation, and the animation effect of camera movement changes is presented in the frame.

In the embodiment of the present disclosure, there are various methods to determine the first animation data corresponding to the target foreground image. Optionally, the first animation data may be determined from at least one preset animation data based on the image type identifier corresponding to the target foreground image; or, the preset animation data corresponding to the foreground image may be directly used as the first animation data, etc.

As an optional implementation of the embodiments of the present disclosure, a plurality of image types may be determined based on the type of the foreground object, and animation data corresponding to the respective image types may be determined separately. Further, after the target foreground image is obtained, an image type identifier corresponding to the target foreground image may be determined. Further, the animation data corresponding to the image type identifier may be determined from at least one preset animation data based on the image type identifier, and the animation data may be used as the first animation data corresponding to the target foreground image. Further, the target foreground image may be processed based on the first animation data to obtain the target foreground animation. Further, the target effect video may be generated based on the target foreground animation and the preset video background information.

According to the technical solution of the embodiment of the present disclosure, the image to be processed is input into the stylization processing model to obtain the target foreground image, and the target effect video is determined based on the target foreground image, achieving the effect of stylizing the foreground object in the image to be processed using the stylization processing model to generate the target foreground image. Further, the target effect video is determined based on the generated target foreground image, and the foreground object in the target effect video is presented in a preset style, thereby enhancing the effect display of the target effect video.

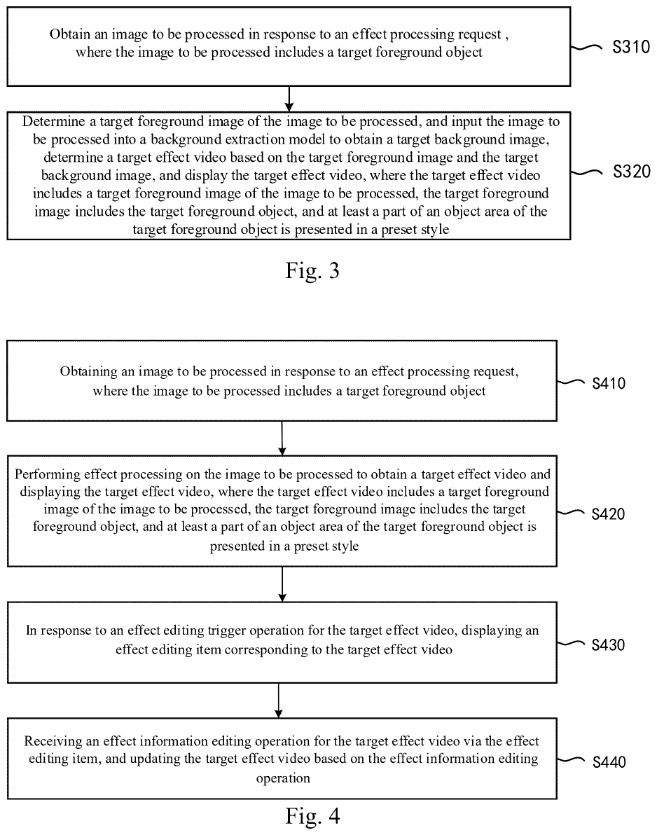

FIG. 3 is a schematic flowchart of another effect processing method according to an embodiment of the present disclosure. The technical solution of this embodiment is based on the above embodiments, where the target foreground image is presented as video foreground information in the target effect video; a video background image is presented in video background information of the target effect video; the video background image includes at least one of the image to be processed, a target background image of the image to be processed, and a preset background image. The process of determining the target effect video is further refined. Optionally, performing effect processing on the image to be processed to obtain a target effect video includes: inputting the image to be processed into a background extraction model to obtain a target background image, and determining a target effect video based on the target foreground image and the target background image. The specific implementation may refer to the description of this embodiment. Technical features that are the same or similar to the foregoing embodiments will not be repeated herein. As shown in FIG. 3, the method of this embodiment may specifically include the following steps.

S310: obtaining an image to be processed in response to an effect processing request, where the image to be processed includes a target foreground object.

S320: determining a target foreground image of the image to be processed, and inputting the image to be processed into a background extraction model to obtain a target background image, determining a target effect video based on the target foreground image and the target background image, and displaying the target effect video; where the target effect video includes a target foreground image of the image to be processed; the target foreground image includes the target foreground object, and at least a part of an object area of the target foreground object is presented in a preset style.

The video background information may refer to the content displayed on a layer below the layer containing the target foreground image in a video frame, or the content in a video frame excluding the image content of the target foreground image. The video background image may be understood as an image located behind the target foreground object in the video frame. The target background image may include an image containing the background information of the image to be processed. The background information of the image to be processed may be understood as image information in the image to be processed other than the target foreground object. The preset background image may be a preset template background image. Optionally, the preset background image includes a solid-color background image (e.g., a black background image, a white background image, and a yellow background image), a background image with preset patterns (e.g., stripes, grids, and irregular patterns), and a background image of another image. The background extraction model may be a neural network model that takes an image as an input object to extract the background image of the image. The background extraction model may be configured to extract the background from the input image. The method for determining the target foreground image may be referred to the implementation method in the foregoing embodiments, and will not be repeated here.

In the embodiment of the present disclosure, the background extraction model is obtained by training a second deep learning model based on a second sample image and the desired background image. Before applying the background extraction model provided in the embodiment of the present disclosure, the prebuilt second deep learning model may be trained using a supervised or unsupervised method. Before training the model, a plurality of training samples may be built to train the model based on the plurality of training samples. Optionally, the training process of the background extraction model may include: obtaining a plurality of training samples, where the training samples include the second sample image and the desired background image; for each of the training samples, inputting the second sample image from the training samples into the prebuilt second deep learning model to extract the background image of the second sample image based on the second deep learning model and outputting the actual background image; determining a loss value based on an actual background image and the desired background image in the training sample; modifying model parameters in the second deep learning model based on the loss value, and taking the convergence of a loss function in the second deep learning model as a training objective, so that the trained second deep learning model can be used as the background extraction model. The second sample image may be an image containing the sample foreground object.

In the embodiment of the present disclosure, after the image to be processed is obtained, the image to be processed may be input into the pre-trained background extraction model. Then, a background image is extracted, from the image to be processed, based on the background extraction model, to output the target background image. Further, the target effect video may be determined based on the target background image and the target foreground image, and then the target effect video is displayed.

It should be noted that there are various methods to determine the target effect video based on the target foreground image and the target background image. Optionally, the target foreground image and/or the target background image may be displayed based on a preset display duration and/or display form, and the video obtained from the display may be used as the target effect video; or, at least one foreground generated image is generated based on the target foreground image, and the target foreground image, at least one foreground generated image, and the target background image is displayed based on the preset display duration and/or display form to obtain the target effect video; or, the target effect video is determined based on the target foreground image, the animation data corresponding to the target foreground image, the target background image, and the animation data corresponding to the target background image.

Optionally, the target effect video includes a video foreground animation and a video background animation. Determining a target effect video based on the target foreground image and the target background image includes determining first animation data corresponding to the target foreground image, and determining the video foreground animation of the target effect video based on the target foreground image and the first animation data; and determining first animation data corresponding to the target background image, and determining the video background animation of the target effect video based on the target background image and the first animation data. Such an setting has the advantages that both the target foreground image and the target background image are presented with animation effects in the target effect video, enriching the effect display of the target effect video, and achieving the effect of separately applying animation effects to the foreground image and background image.

The second animation data may be understood as data that enables an image and/or video it acts upon to be presented with a preset animation effect. In the embodiment of the present disclosure, the second animation data may be animation data corresponding to the target background image, i.e., the second animation data is pre-determined animation data applied to the target background image. The video background animation may be understood as animated elements and/or dynamic effects in the part of background of a video frame. For example, the second animation data may be combined animation data of a border and camera movement changes. Further, the video background animation may be a frame with a border, where the target background image is inside the border, and the frame presents an animated effect of camera movement changes.

In the embodiment of the present disclosure, there are various methods to determine the second animation data corresponding to the target background image. Optionally, the first animation data may be determined from at least one preset animation data based on an image type identifier corresponding to the target background image; or, the preset animation data corresponding to the background image may be directly used as the second animation data, etc.

As an optional implementation of the embodiments of the present disclosure, a plurality of foreground image types may be determined based on the type of the foreground object, animation data corresponding to the respective foreground image types may be determined separately, and the determined animation data is used as candidate animation data corresponding to the foreground image. Moreover, the background image type of a plurality of background images may be determined, the animation data corresponding to the respective background image types may be determined separately, and the determined animation data is used as candidate animation data corresponding to the background image. Further, after the target foreground image is obtained, a foreground image type identifier corresponding to the target foreground image may be determined. Further, based on a foreground image type identifier, the animation data corresponding to the foreground image type identifier may be determined from the preset candidate animation data corresponding to the foreground image, and the animation data may be used as the first animation data corresponding to the target foreground image. Further, the target foreground image may be processed based on the first animation data to obtain the target foreground animation. Additionally, after the target background image is obtained, a background image type identifier corresponding to the target background image may be determined. Further, based on the background image type identifier, the animation data corresponding to the background image identifier may be determined from the preset candidate animation data corresponding to the background image, and the animation data may be used as the second animation data corresponding to the target background image. Further, the target background image may be processed based on the second animation data to obtain the target background animation. Further, the target foreground animation and the target background animation may be used as the target effect video.

According to the technical solution of the present disclosure, by inputting the image to be processed into the background extraction model to obtain the target background image, and determining the target effect video based on the target foreground image and the target background image, the extraction of the background image of the image based on the background extraction model is achieved; by determining the effect of the target effect video based on the background image and the foreground image, the effect of the target effect video is determined based on the foreground image and the background image of the image to be processed, thereby enhancing the relation between the target effect video and the image to be processed, and making the final target effect video more closely aligned with the image to be processed.

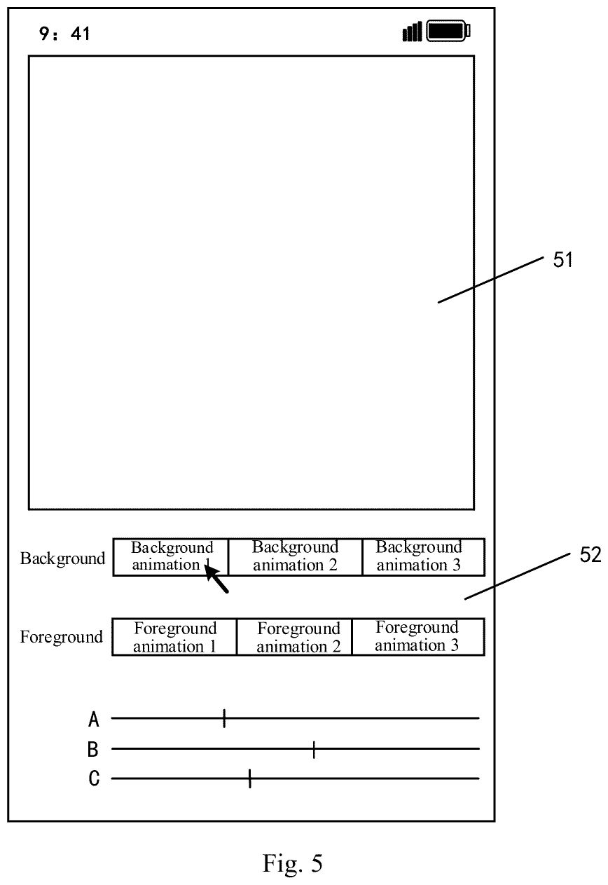

FIG. 4 is a schematic flowchart of another effect processing method according to an embodiment of the present disclosure. The technical solution of this embodiment is based on the above embodiments, where the target effect video may be edited after it is displayed, and the target effect video is updated based on an editing operation for effect information. Optionally, after displaying the target effect video, the effect processing method further includes: in response to an effect editing trigger operation for the target effect video, displaying an effect editing item corresponding to the target effect video, where the effect editing item includes an image content editing item and/or an image effect editing item; and receiving an editing operation for effect information for the target effect video via the effect editing item, and updating the target effect video based on the editing operation for effect information. The specific implementation may refer to the description of this embodiment. Technical features that are the same or similar to the foregoing embodiments will not be repeated herein. As shown in FIG. 4, the method of this embodiment may specifically include S410, S420, S430, and S440.

S410: obtaining an image to be processed in response to an effect processing request, where the image to be processed includes a target foreground object.

S420: performing effect processing on the image to be processed to obtain a target effect video and displaying the target effect video; where the target effect video includes a target foreground image of the image to be processed; the target foreground image includes the target foreground object, and at least a part of an object area of the target foreground object is presented in a preset style.

S430: in response to an effect editing trigger operation for the target effect video, displaying an effect editing item corresponding to the target effect video.

The effect editing trigger operation may be understood as an operation that makes the target effect video editable so that the effect information corresponding to the target effect video can be edited. Optionally, the effect editing trigger operation includes at least one of the following operations: triggering a preset effect editing control, clicking for the input of the target effect video (e.g., single click and multiple clicks), receiving audio information that includes trigger words associated with the effect editing operation, receiving a video editing instruction, etc. The effect editing item may be understood as an interactive operation entry for editing effect information corresponding to the target effect video. The effect editing item may be used for editing the effect information corresponding to the target effect video. Optionally, the effect editing item includes an image content editing item and/or an image effect editing item. The image content editing item may be used for editing the image content included in the target effect video. In the embodiment of the present disclosure, the image content included in the target effect video includes at least one of the image to be processed, the target foreground image, and the target background image. The image content editing item includes at least one of a first image editing item corresponding to the image to be processed, a second image editing item corresponding to the target foreground image, and a third image editing item corresponding to the target background image. The first image editing item may be used for editing the image content of the image to be processed. The second image editing item may be used for editing the image content of the target foreground image. The third image editing item may be used for editing the image content of the target background image. The image effect editing item may be used for editing the image effects presented in the target effect video. The image effect editing item may include an animation effect editing item and/or a display duration editing item. The animation effect editing item may be used for editing the animation effect presented in the target effect video. The display duration editing item may be used for editing the display duration of the target effect video.

As an optional implementation of the embodiments of the present disclosure, after the target effect video is displayed, a display interface of the target effect video may include an effect editing control. Further, when a control trigger operation targeting the effect editing control is detected, it can be determined that an effect editing trigger operation for the target effect video has been received. Further, in response to the effect editing trigger operation, the effect editing item corresponding to the target effect video is displayed.

S440: receiving an editing operation for effect information for the target effect video via the effect editing item, and updating the target effect video based on the editing operation for effect information.

The editing operation for effect information may be understood as an operation for editing effect information corresponding to the target effect video. Optionally, the editing operation for effect information corresponding to the image content editing item includes at least one of the following operations: image replacement, image addition, image display order adjustment, and image deletion. The editing operation for effect information corresponding to the animation effect editing item includes at least one of the following operations: animation effect replacement, animation effect addition, and animation effect deletion.

In the embodiment of the present disclosure, in response to displaying the effect editing item corresponding to the target effect video, the editing operation for effect information for the target effect video may be input via the effect editing item. Further, in response to receiving the editing operation for effect information for the target effect video, the target effect video may be updated based on the received effect editing operation.

As an optional implementation of this embodiment, in response to the editing operation for effect information including the image display order adjustment operation, updating the target effect video based on the editing operation for effect information includes: displaying the video image included in the target effect video according to a preset image display mode, where the image display mode includes image display layers and/or image display order, the video image includes a target foreground image or includes a target foreground image and a video background image; receiving the image display order adjustment operation for the video image, updating the image display mode of the video image based on the image display order adjustment operation, and changing the image display order of the video image in the target effect video, and previewing the updated target effect video.

More specifically, in response to receiving the editing operation for effect information, the video images included in the target effect video may be determined, and the video images may be displayed based on the image display layers and image display order, so that the target foreground image in the video images is displayed in a foreground layer display area, and the video background image in the video images is displayed in a background layer display area. In order to facilitate targeted interaction with the respective video images, a plurality of slots may be set up in the foreground layer display area and/or background layer display area, and each of the slots is designed to hold a single video image. The target foreground image and/or the video background image are displayed in the slots based on the image display order of the video images in the target effect video. Further, when the image display order adjustment operation for the target foreground image is detected, the slot occupied by the target foreground image in the foreground layer display area may be updated based on the image display order adjustment operation. In response to the presence of the video background image associated with the target foreground image, the display position of the video background image in the background layer display area may be updated based on the updated target foreground image. Further, the image display order of the video image in the target effect video may be updated based on the updated video image. Herein, the slot may be understood as a data space available for adding a video image.

As an optional implementation of this embodiment of the present disclosure, in response to the editing operation for effect information including the image replacement operation, updating the target effect video based on the editing operation for effect information includes: displaying the video image included in the target effect video according to a preset image display mode, where the image display mode includes image display layers and/or image display order, the video image includes a target foreground image or includes a target foreground image and a video background image; in response to receiving an image replacement operation for the video background image, determining the replaced video background image based on the image replacement operation, and updating the target effect video based on the replaced video background image and its associated target foreground image.

More specifically, in response to receiving an editing operation for effect information, the video image included in the target effect video may be displayed based on the image display layers and image display order, where the video image includes the target foreground image or includes both the target foreground image and the video background image. Further, in response to receiving an image replacement operation for the video background image, at least one candidate effect image may be displayed, where the at least one candidate effect image includes a candidate background image and/or a candidate image. The, in response to receiving an image selection operation for the candidate image, the background image corresponding to the candidate image may be determined, and the video background image may be replaced based on the background image. Further, the target effect video may be updated based on the replaced video background image and the target foreground image.

As an optional implementation of the embodiments of the present disclosure, in response to the editing operation for effect information including the image deletion operation, updating the target effect video based on the editing operation for effect information includes: displaying the video image included in the target effect video according to a preset image display mode, where the image display mode includes image display layers and/or image display order, the video image includes a target foreground image or includes a target foreground image and a video background image; receiving an image deletion operation for the foreground image and/or background image of the target video; when there is an associated image of the image to be deleted, removing the image to be deleted from its slot to update the target effect video, where the display mode of the remaining video images remains unchanged; and, in the absence of associated image of the image to be deleted, deleting the image to be deleted from its slot, and sequentially shifting the remaining video images forward according to their relative display relationships in the target video file to enable continuous playback of the remaining video images; and updating the target effect video based on the adjusted the video image. In response to that the image to be deleted is the target foreground image, the associated image of the image to be deleted is the video background image; in response to that the image to be deleted is the video background image, the associated image of the image to be deleted is the target foreground image. The relative display relationship includes the way of displaying the video foreground image and the video background image in relation to each other, such as relative display time.

Optionally, the image effect editing item includes an animation effect editing item; the animation effect editing item includes an animation duration editing item. Receiving an editing operation for effect information for the target effect video via the effect editing item, and updating the target effect video based on the editing operation for effect information includes: receiving an animation duration editing operation for the target effect video via the animation duration editing item, and determining an animation acting object and animation duration editing information in the target effect video based on the animation duration editing operation; and determining an animation acting duration based on a display duration of the animation acting object and the animation duration editing information, and updating the target effect video based on the animation acting object and the animation acting duration. Such a setting has the advantages of, after the target effect video is obtained, enabling customized editing of the animation duration in the target effect video, thereby enriching the effect processing methods and enriching the effect display of the effect video.

The animation duration editing item may be understood as an interactive entry for editing the animation display duration of the target effect video. The display form of the animation duration editing item may include various options, such as a duration pointer slider and/or a duration editing box. The animation duration editing operation may be understood as an operation for editing the animation display video of the target effect video. The animation duration editing operation may include selecting the animation acting object and editing duration information. The animation acting object may be understood as the target object of the relevant animation data. In other words, in the process of determining the target effect video, the first animation data corresponding to the target foreground image and/or the second animation data corresponding to the target background image may be determined. Further, the first animation data may be applied to the target foreground image to obtain the video foreground animation; and the second animation data may be applied to the target background image to obtain the video background animation. The target foreground image acted upon by the first animation data and the target background image acted upon by the second animation data may be used as the animation acting object. Optionally, the animation acting object include at least one of the target foreground image, the target foreground object within the target foreground image, and the target background image. The animation duration editing information may be understood as the duration information obtained after the animation duration is edited. The object display duration may be a display duration of the corresponding animation acting object in the target effect video. The animation acting duration may be understood as an acting duration of the animation data; or, the animation acting duration may also be understood as a display duration of the animation effect.

As an optional implementation of the embodiments of the present disclosure, when the displayed effect editing item includes an animation duration editing item, the animation duration editing item may be displayed in the form of the duration pointer slider in an editing interface corresponding to the target effect video. Further, when an object selection operation for a candidate animation acting object is detected, the animation acting object in the target effect video may be determined based on the object selection operation, and the duration pointer slider corresponding to the animation acting object may be displayed. Further, when a pointer editing operation for the duration pointer slider is detected, the animation duration editing information may be determined based on the pointer editing operation. Further, when the animation acting object and the animation duration editing information are determined, the object display duration of the animation acting object in the target effect video may be determined, and the object display duration may be processed based on the animation duration editing information to determine the animation acting duration of the animation acting object. Further, the target effect video may be updated based on the animation acting object and the animation acting duration. For example, the animation duration of the target effect video may be represented by a progress value ranging from 0 to 100%, with 50% as the duration center point. Further, the display position of the duration center point on the duration pointer slider may be adjusted, and an animation duration scaling ratio may be determined based on the adjusted display position. The animation acting duration may be determined based on the animation duration scaling ratio, and the target effect video may be updated based on the animation acting duration.

As an example, FIG. 5 is a schematic diagram of an interface display for an effect editing process according to an embodiment of the present disclosure. As shown in FIG. 5, the display interface includes a video display area 51 and a video editing area 52. The video display area 51 may be used for displaying a target effect video. The video editing area 52 may be used for displaying an animation acting object included in the target effect video and an effect editing item corresponding to the animation acting object. The video editing area 52 displays the animation acting object in the form of slots, including background slots and foreground slots. The background slots include a background animation 1, a background animation 2, and a background animation 3. The foreground slots include a foreground animation 1, a foreground animation 2, and a foreground animation 3. When a drag operation for an animation identifier of the background animation 1 is detected, the slot position of the background animation 1 may be transformed based on the animation drag operation to change its display order in the target effect video. Further, when a drag operation for dragging the background animation 1 to the slot position occupied by the background animation 2 is detected, the slot positions of the background animation 2 and the background animation 1 may be swapped. When a selection trigger operation for the background animation 1 is detected, the effect editing items corresponding to the background animation 1 may be displayed in the video editing area 52. The effect editing items may include an effect editing item A, an effect editing item B, and an effect editing item C. The effect editing item A, the effect editing item B, and the effect editing item C are used for editing different effect information, respectively. Further, when an editing operation for effect information for the effect editing item A, the effect editing item B, and/or the effect editing item C is detected, the effect editing information may be determined based on the editing operation for effect information. Then, the target effect video is updated based on the effect editing information.

According to the technical solution of the embodiment of the present disclosure, in response to an effect editing trigger operation for the target effect video, an effect editing item corresponding to the target effect video is displayed; where the effect editing item includes an image content editing item and/or image effect editing item; and further, an editing operation for effect information for the target effect video is received via the effect editing item, and the target effect video is updated based on the editing operation for effect information, achieving customized editing of the effect information of the target effect video after the target effect video is obtained, thereby enriching the effect processing method, enriching the effect display of the effect video, and improving the effect processing experience.

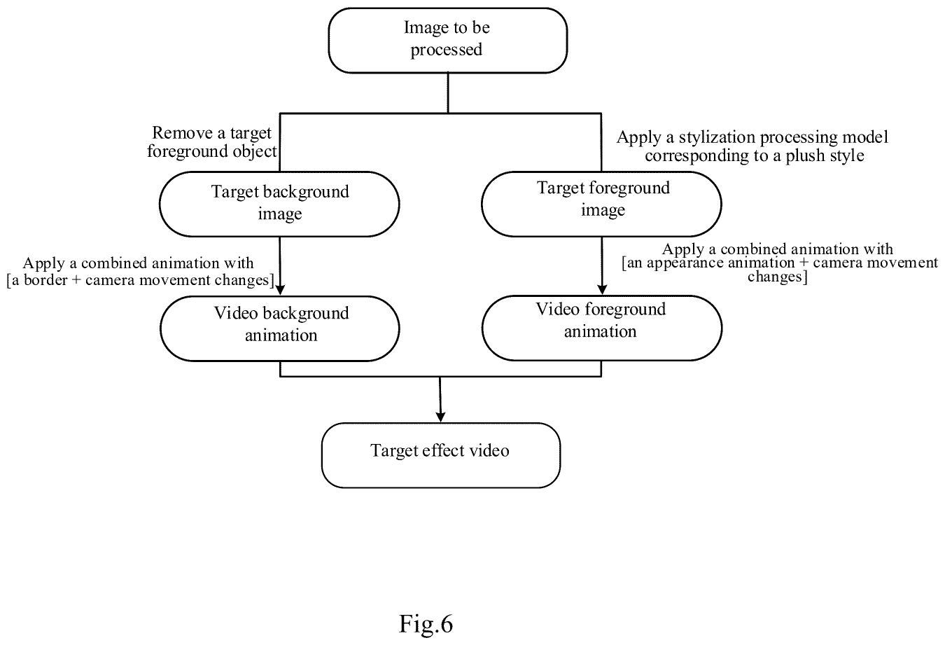

FIG. 6 is a schematic flowchart of an effect processing method according to an embodiment of the present disclosure. The embodiment is a preferred embodiment of the above embodiments. As shown in FIG. 6, the method of this embodiment may specifically include the following steps.

First, an image to be processed is obtained, which includes a target foreground object and background information corresponding to the target foreground object. Further, the image to be processed may be subjected to background area extraction, and an area, corresponding to the target foreground object, in the background area may be filled to obtain a target background image. Then, combined animation data with border effects and camera movement effects may be applied to the target background image to obtain a video background animation. Additionally, the target foreground object in the image to be processed may be extracted using a stylization processing model corresponding to the plush style, and the target foreground object may be stylized to obtain a target foreground image. Then, combined animation data including an appearance animation and camera movement changes may be applied to the target foreground image to obtain a video foreground animation. Further, the video background animation and the video foreground animation may be combined to form a target effect video.

According to the technical solution of the present disclosure, during the effect processing, the target foreground object can be identified automatically and extracted from the image to be processed, and the target foreground object can be stylized to obtain the stylized target foreground image so as to generate the target effect video containing the target foreground image, thereby achieving differentiated processing of the target foreground object in the image to be processed, enriching the effect processing methods, enhancing the content depth of the image after effect processing, and improving the effect interaction experience.

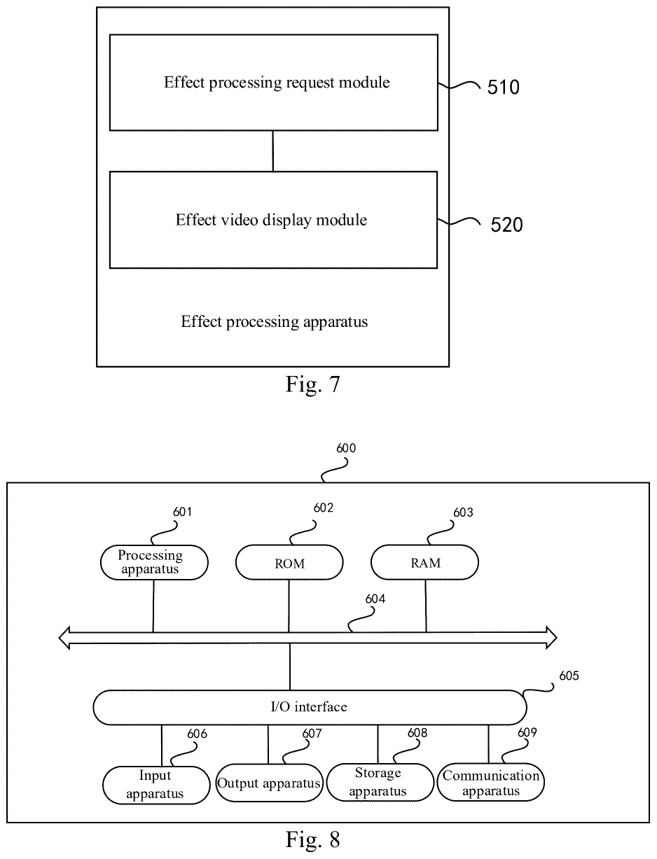

FIG. 7 is a schematic diagram of a structure of an effect processing apparatus according to an embodiment of the present disclosure. As shown in FIG. 7, the apparatus includes an effect processing request module 510 and an effect video display module 520. The effect processing request module 510 is configured to obtain an image to be processed in response to an effect processing request, where the image to be processed includes a target foreground object. The effect video display module 520 is configured to perform effect processing on the image to be processed to obtain a target effect video and display the target effect video; where the target effect video includes a target foreground image of the image to be processed; the target foreground image includes the target foreground object, and at least a part of an object area of the target foreground object is presented in a preset style.

According to the technical solution of the embodiment of the present disclosure, by means of the effect processing request module 510, the image to be processed is obtained in response to the effect processing request, the obtaining of the image to be processed may be triggered by a single interactive operation, and the image to be processed includes the target foreground object, providing a data foundation for subsequent effect processing of the foreground object in the image. Further, by means of the effect video display module 520, the image to be processed is subjected to effect processing to obtain the target effect video, and then the target effect video is displayed; where the target effect video includes the target foreground image of the image to be processed; the target foreground image includes the target foreground object, and at least a part of the object area of the target foreground object is presented in the preset style. In this way, the problem that the presentation of effects in related technologies is rather monotonous and lacks interest is solved; during the effect processing, the target foreground object can be identified automatically and extracted from the image to be processed, and the target foreground object can be stylized to obtain stylized target foreground image, so as to generate the target effect video containing the target foreground image, thereby achieving differentiated processing of the target foreground object in the image to be processed, enriching the effect processing methods, enhancing the content depth of the image after effect processing, and improving the effect interaction experience.

Based on any of the optional technical solutions in the embodiments of the present disclosure, optionally, the target foreground image is presented as video foreground information in the target effect video; and the effect video display module 520 includes: an effect video first determination unit. The effect video first determination unit is configured to, input the image to be processed into a stylization processing model to obtain a target foreground image, and determine a target effect video based on the target foreground image; where the stylization processing model is obtained by training a first deep learning model based on a first sample image and a desired foreground image; the desired foreground image includes a sample foreground object in the first sample image, and the sample foreground object is presented in a preset style.

Based on any of the optional technical solutions in the embodiments of the present disclosure, optionally, the effect video first determination unit is specifically configured to determine first animation data corresponding to the target foreground image, determine a video foreground animation based on the target foreground image and the first animation data, and determine a target effect video based on the video foreground animation.

Based on any of the optional technical solutions in the embodiments of the present disclosure, optionally, the target foreground image is presented as video foreground information in the target effect video; a video background image is presented in video background information of the target effect video; the video background image includes at least one of the image to be processed, a target background image of the image to be processed, and a preset background image.

Based on any of the optional technical solutions in the embodiments of the present disclosure, optionally, the video background image includes the target background image of the image to be processed; and the effect video display module 520 includes an effect video second determination unit. The effect video second determination unit is configured to determine a target foreground image of the image to be processed, and input the image to be processed into a background extraction model to obtain a target background image, and determine a target effect video based on the target foreground image and the target background image; where the background extraction model is obtained by training a second deep learning model based on a second sample image and a desired background image.

Based on any of the optional technical solutions in the embodiments of the present disclosure, optionally, the target effect video includes a video foreground animation and a video background animation; and the effect video second determination unit includes a foreground animation determination subunit and a background animation determination subunit. The foreground animation determination subunit is configured to determine first animation data corresponding to the target foreground image, and determine video foreground animation of the target effect video based on the target foreground image and the first animation data. The background animation determination subunit is configured to determine second animation data corresponding to the target background image, and determine video background animation of the target effect video based on the target background image and the second animation data.

Based on any of the optional technical solutions in the embodiments of the present disclosure, optionally, in the target effect video, the target foreground image is displayed with a first animation effect; when the target effect video includes a target background image of the image to be processed, the target foreground image is displayed with the first animation effect, and the target background image is displayed with a second animation effect; when the target effect video includes the image to be processed and the target background image of the image to be processed, the target foreground image is displayed with the first animation effect, the target background image is displayed with the second animation effect, and the image to be processed is displayed with a third animation effect.

Based on any of the optional technical solutions in the embodiments of the present disclosure, optionally, the effect video display module 520 is specifically configured to, in response to the presence of a plurality of images to be processed, determine an image effect video corresponding to each of the images to be processed, and determine a target effect video based on the image effect videos corresponding to the plurality of images to be processed.

Based on any of the optional technical solutions in the embodiments of the present disclosure, optionally, the apparatus further includes an edit item display module and an effect editing module. The edit item display module is configured to, in response to an effect editing trigger operation for the target effect video, display an effect editing item corresponding to the target effect video; where the effect editing item includes an image content editing item and/or an image effect editing item; and the effect editing module is configured to receive an editing operation for effect information for the target effect video via the effect editing item, and update the target effect video based on the editing operation for effect information.

Based on any of the optional technical solutions in the present disclosure, optionally, the image effect editing item includes an animation effect editing item; the animation effect editing item includes an animation duration editing item; the effect editing module includes: a duration editing unit and an effect video updating unit. The duration editing unit is configured to receive an animation duration editing operation for the target effect video via the animation duration editing item, and determine an animation acting object and animation duration editing information in the target effect video based on the animation duration editing operation. The effect video updating unit is configured to determine an animation acting duration based on a display duration of the animation acting object and the animation duration editing information, and update the target effect video based on the animation acting object and the animation acting duration.

The effect processing apparatus provided in the embodiments of the present disclosure may execute the effect processing method provided in any embodiment of the present disclosure, and has the corresponding functional modules for executing the effect processing method and beneficial effects.

It should be noted that the various units and modules included in the above-mentioned apparatus are divided according to functional logic, but are not limited to the above divisions, as long as they can achieve the corresponding functions. In addition, the specific names of the respective functional units are only for the purpose of distinguishing them from each other and are not used to limit the scope of protection of the embodiments of the present disclosure.

Specific reference is made below to FIG. 8, which shows a schematic diagram of a structure of an electronic device 600 (e.g., terminal or server) applicable to implementing embodiments of the present disclosure. The terminal in the embodiments of the present disclosure may include, but is not limited to, a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and a fixed terminal such as a digital TV, a desktop computer, or the like. The electronic device illustrated in FIG. 8 is merely an example and should not impose any limitations on the function and scope of application of the embodiments of the present disclosure.

As shown in FIG. 8, the electronic device 600 may include a processing apparatus 601 (e.g., a central processing unit and a graphics processing unit) which can perform various suitable actions and processing according to a program stored in a read-only memory (ROM) 602 or a program loaded from a storage apparatus 608 into a random-access memory (RAM) 603. The RAM 603 further stores various programs and data required for operations of the network model compression device 600. The processing apparatus 601, the ROM 602, and the RAM 603 are interconnected by means of a bus 604. An input/output (I/O) interface 605 is also connected to the bus 604.

Usually, the following apparatuses may be connected to the I/O interface 605: an input apparatus 606 including, for example, a touch screen, a touch pad, a keyboard, a mouse, a camera, a microphone, an accelerometer, a gyroscope, and the like; an output apparatus 607 including, for example, a liquid crystal display (LCD), a loudspeaker, a vibrator, and the like; a storage apparatus 608 including, for example, a magnetic tape, and a hard disk; and a communication apparatus 609. The communication apparatus 609 may allow the electronic device 600 to be in wireless or wired communication with other devices to exchange data. While FIG. 8 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, embodiments of the present disclosure include a computer program product, which includes a computer program carried by a non-transitory computer-readable medium. The computer program includes program code for performing the methods shown in the flowcharts. In such embodiments, the computer program may be downloaded and installed from a network through the communication apparatus 609, or may be installed from the storage apparatus 608, or may be installed from the ROM 602. When the computer program is executed by the processing apparatus 601, the above-mentioned functions defined in the methods of some embodiments of the present disclosure are performed.

The names of messages or information interacted between a plurality of apparatuses in the embodiments of the present disclosure are used for illustrative purposes only and are not intended to limit the scope of those messages or information.

The electronic device provided in the embodiment of the present disclosure and the effect processing method provided in the above embodiments belong to the same disclosure conception, and the technical details not described in detail in the embodiments of the present disclosure may refer to the foregoing embodiments, and the same technical features have the same beneficial effects in the present embodiments and the embodiments described above.

Embodiments of the present disclosure provide a computer storage medium, having a computer program stored therein. The computer program is executed by a processor to implement the effect processing method provided in the foregoing embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. Moreover, in the context of the present disclosure, the computer-readable signal medium may include a data signal propagated in a baseband or as part of a carrier, the data signal carrying a computer-readable program code. Such propagated data signal may have a variety of forms, including, but not limited to, an electromagnetic signal, an optical signal, or any suitable combination of the foregoing. The computer-readable signal medium may also be any computer-readable medium other than the computer-readable storage medium that sends, propagates, or transmits a program for use by, or in combination with, an instruction executing system, apparatus, or device. The program code contained on the computer-readable medium may be transmitted by using any suitable medium, including but not limited to an electric wire, a fiber-optic cable, radio frequency (RF) and the like, or any appropriate combination of them.

According to one or more embodiments of the present disclosure, Example one provides an effect processing method, which includes: obtaining an image to be processed in response to an effect processing request, where the image to be processed includes a target foreground object; performing effect processing on the image to be processed to obtain a target effect video and displaying the target effect video; where the target effect video includes a target foreground image of the image to be processed; the target foreground image includes the target foreground object, and at least a part of an object area of the target foreground object is presented in a preset style.

According to one or more embodiments of the present disclosure, example two provides the method described in example one, which further includes: optionally, the target foreground image is presented as video foreground information in the target effect video; and performing effect processing on the image to be processed to obtain a target effect video includes: inputting the image to be processed into a stylization processing model to obtain a target foreground image, and determining a target effect video based on the target foreground image; where the stylization processing model is obtained by training a first deep learning model based on a first sample image and a desired foreground image; the desired foreground image includes a sample foreground object in the first sample image, and the sample foreground object is presented in a preset style.

According to one or more embodiments of the present disclosure, example three provides the method described in example two, which further includes: optionally, determining a target effect video based on the target foreground image, including determining first animation data corresponding to the target foreground image, determining a video foreground animation based on the target foreground image and the first animation data, and determining a target effect video based on the video foreground animation.

According to one or more embodiments of the present disclosure, example four provides the method described in example one, which further includes: optionally, the target foreground image is presented as video foreground information in the target effect video; a video background image is presented in video background information of the target effect video; the video background image includes at least one of the image to be processed, a target background image of the image to be processed, and a preset background image.

According to one or more embodiments of the present disclosure, example five provides the method described in example four, which further includes: optionally, the video background image includes the target background image of the image to be processed; and performing effect processing on the image to be processed to obtain a target effect video includes: determining a target foreground image of the image to be processed, inputting the image to be processed into a background extraction model to obtain a target background image, and determining a target effect video based on the target foreground image and the target background image; where the background extraction model is obtained by training a second deep learning model based on a second sample image and a desired background image.

According to one or more embodiments of the present disclosure, example six provides the method described in example five, which further includes: optionally, the target effect video includes a video foreground animation and a video background animation; and determining a target effect video based on the target foreground image and the target background image includes: determining first animation data corresponding to the target foreground image, and determining a video foreground animation of the target effect video based on the target foreground image and the first animation data; and determining second animation data corresponding to the target background image, and determining a video background animation of the target effect video based on the target background image and the second animation data.

According to one or more embodiments of the present disclosure, example seven provides the method described in example one, which further includes: optionally, in the target effect video, the target foreground image is displayed with a first animation effect; when the target effect video includes a target background image of the image to be processed, the target foreground image is displayed with the first animation effect, the target background image is displayed with a second animation effect; when the target effect video includes the image to be processed and the target background image of the image to be processed, the target foreground image is displayed with the first animation effect, the target background image is displayed with the second animation effect, and the image to be processed is displayed with a third animation effect.

According to one or more embodiments of the present disclosure, example eight provides the method described in example one, which further includes: optionally, performing effect processing on the image to be processed to obtain a target effect video, including: in response to the presence of a plurality of images to be processed, determining an image effect video corresponding to each of the images to be processed, and determining a target effect video based on the image effect videos corresponding to the multiple images to be processed.

According to one or more embodiments of the present disclosure, example nine provides the method described in example one, which further includes: optionally, after displaying the target effect video, in response to an effect editing trigger operation for the target effect video, displaying an effect editing item corresponding to the target effect video; where the effect editing item includes an image content editing item and/or an image effect editing item; and receiving an editing operation for effect information for the target effect video via the effect editing item, and updating the target effect video based on the editing operation for effect information.

According to one or more embodiments of the present disclosure, example ten provides the method described in example nine, which further includes: optionally, the image effect editing item includes an animation effect editing item; the animation effect editing item includes an animation duration editing item; receiving an editing operation for effect information for the target effect video via the effect editing item, and updating the target effect video based on the editing operation for effect information includes: receiving an animation duration editing operation for the target effect video via the animation duration editing item, and determining an animation acting object and animation duration editing information in the target effect video based on the animation duration editing operation; and determining an animation acting duration based on a display duration of the animation acting object and the animation duration editing information, and updating the target effect video based on the animation acting object and the animation acting duration.

According to one or more embodiments of the present disclosure, example eleven provides an effect processing apparatus, which includes: an effect processing request module, configured to obtain an image to be processed in response to an effect processing request, where the image to be processed includes a target foreground object; and an effect video display module, configured to perform effect processing on the image to be processed to obtain a target effect video and display the target effect video; where the target effect video includes a target foreground image of the image to be processed; the target foreground image includes the target foreground object, and at least a part of an object area of the target foreground object is presented in a preset style.

In some implementations, the client and the server may communicate utilizing any currently known or future developed network protocol such as HTTP (Hyper Text Transfer Protocol) and may be interconnected in communication with digital data (e.g., communication networks) of any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The computer-readable medium carries one or more programs, and when one or more of the programs is executed by the electronic device, it causes the electronic device to perform: obtaining an image to be processed in response to an effect processing request, where the image to be processed includes a target foreground object; performing effect processing on the image to be processed to obtain a target effect video and displaying the target effect video; where the target effect video includes a target foreground image of the image to be processed; the target foreground image includes the target foreground object, and at least a part of an object area of the target foreground object is presented in a preset style.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the effect processing module may also be described as a “module for obtaining an image to be processed”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing descriptions are merely preferred examples of the present disclosure and explanations of the technical principles used. Persons skilled in the art should understand that the related scope disclosed in the present disclosure is not limited to the technical solutions formed by a specific combination of the foregoing technical characteristics, and should also cover other technical solutions formed by any combination of the foregoing technical features or their equivalent features without departing from the above disclosed conception. For example, the technical solution formed by replacement between the foregoing features and technical features having similar functions disclosed (but not limited thereto) in the present disclosure.

Additionally, although operations are depicted in a particular order, this should be understood that such operations are required to be performed in the particular order shown or in a sequential order. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single embodiment. Conversely, various features that are described in the context of a single embodiment may also be implemented in a plurality of embodiments separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. An effect processing method, comprising:
obtaining a first image in response to an effect processing request, wherein the first image comprises a first foreground object; and
performing effect processing on the first image to obtain a first video and displaying the first video, wherein the first video comprises a first foreground image of the first image, the first foreground image comprises the first foreground object, and at least a part of an object area of the first foreground object is presented in a preset style.

2. The effect processing method according to claim 1, wherein the first foreground image is presented as video foreground information in the first video, and the performing effect processing on the first image to obtain a first video comprises:
inputting the first image into a stylization processing model to obtain the first foreground image, and determining the first video based on the first foreground image, wherein the stylization processing model is obtained by training a first deep learning model based on a first sample image and a desired foreground image, the desired foreground image comprises a sample foreground object in the first sample image, and the sample foreground object is presented in a preset style.

3. The effect processing method according to claim 2, wherein determining the first video based on the first foreground image comprises:
determining first animation data corresponding to the first foreground image, determining a video foreground animation based on the first foreground image and the first animation data, and determining the first video based on the video foreground animation.

4. The effect processing method according to claim 1, wherein the first foreground image is presented as video foreground information in the first video, a video background image is presented in video background information of the first video, the video background image comprises at least one selected from the group consisting of the first image, a first background image of the first image, and a preset background image.

5. The effect processing method according to claim 4, wherein the video background image comprises the first background image of the first image, and the performing effect processing on the first image to obtain a first video comprises:
determining the first foreground image of the first image, inputting the first image into a background extraction model to obtain the first background image, and determining the first video based on the first foreground image and the first background image, wherein the background extraction model is obtained by training a second deep learning model based on a second sample image and a desired background image.

6. The effect processing method according to claim 5, wherein the first video comprises a video foreground animation and a video background animation, and the determining the first video based on the first foreground image and the first background image comprises:
determining first animation data corresponding to the first foreground image, and determining the video foreground animation of the first video based on the first foreground image and the first animation data; and
determining second animation data corresponding to the first background image, and determining the video background animation of the first video based on the first background image and the second animation data.

7. The effect processing method according to claim 1, wherein, in the first video, the first foreground image is displayed with a first animation effect; in response to the first video comprising a first background image of the first image, the first foreground image is displayed with the first animation effect, and the first background image is displayed with a second animation effect; in response to the first video comprising the first image and the first background image of the first image, the first foreground image is displayed with the first animation effect, the first background image is displayed with the second animation effect, and the first image is displayed with a third animation effect.

8. The effect processing method according to claim 1, wherein the performing effect processing on the first image to obtain a first video comprises:
in response to the presence of a plurality of first images, determining a plurality of image videos, each of the image videos corresponding to a respective one of the first images, and determining the first video based on the plurality of image videos.

9. The effect processing method according to claim 1, wherein after the displaying the first video, the effect processing method further comprises:
in response to an effect editing trigger operation for the first video, displaying an effect editing item corresponding to the first video, wherein the effect editing item comprises at least one selected from the group consisting of an image content editing item and an image effect editing item; and
receiving an editing operation for effect information of the first video via the effect editing item, and updating the first video based on the editing operation for effect information.

10. The effect processing method according to claim 9, wherein the image effect editing item comprises an animation effect editing item, the animation effect editing item comprises an animation duration editing item, and the receiving an editing operation for effect information of the first video via the effect editing item, and updating the first video based on the editing operation for effect information comprises:
receiving an animation duration editing operation for the first video via the animation duration editing item, and determining an animation acting object and animation duration editing information in the first video based on the animation duration editing operation; and
determining an animation acting duration based on a display duration of the animation acting object and the animation duration editing information, and updating the first video based on the animation acting object and the animation acting duration.

11. An electronic device, comprising:
at least one processor; and
a storage apparatus for storing at least one program;
in response to the at least one program being executed by the at least one processor, causing the at least one processor to implement an effect processing method, wherein the effect processing method comprises:
obtaining a first image in response to an effect processing request, wherein the first image comprises a first foreground object; and
performing effect processing on the first image to obtain a first video and displaying the first video, wherein the first video comprises a first foreground image of the first image, the first foreground image comprises the first foreground object, and at least a part of an object area of the first foreground object is presented in a preset style.

12. The electronic device according to claim 11, wherein the first foreground image is presented as video foreground information in the first video, and the performing effect processing on the first image to obtain a first video comprises:
inputting the first image into a stylization processing model to obtain the first foreground image, and determining the first video based on the first foreground image, wherein the stylization processing model is obtained by training a first deep learning model based on a first sample image and a desired foreground image, the desired foreground image comprises a sample foreground object in the first sample image, and the sample foreground object is presented in a preset style.

13. The electronic device according to claim 12, wherein determining the first video based on the first foreground image comprises:
determining first animation data corresponding to the first foreground image, determining a video foreground animation based on the first foreground image and the first animation data, and determining the first video based on the video foreground animation.

14. The electronic device according to claim 11, wherein the first foreground image is presented as video foreground information in the first video, a video background image is presented in video background information of the first video, the video background image comprises at least one selected from the group consisting of the first image, a first background image of the first image, and a preset background image.

15. The electronic device according to claim 14, wherein the video background image comprises the first background image of the first image, and the performing effect processing on the first image to obtain a first video comprises:
determining the first foreground image of the first image, inputting the first image into a background extraction model to obtain the first background image, and determining the first video based on the first foreground image and the first background image, wherein the background extraction model is obtained by training a second deep learning model based on a second sample image and a desired background image.

16. The electronic device according to claim 15, wherein the first video comprises a video foreground animation and a video background animation, and the determining the first video based on the first foreground image and the first background image comprises:
determining first animation data corresponding to the first foreground image, and determining the video foreground animation of the first video based on the first foreground image and the first animation data; and
determining second animation data corresponding to the first background image, and determining the video background animation of the first video based on the first background image and the second animation data.

17. The electronic device according to claim 11, wherein, in the first video, the first foreground image is displayed with a first animation effect; in response to the first video comprising a first background image of the first image, the first foreground image is displayed with the first animation effect, and the first background image is displayed with a second animation effect; in response to the first video comprising the first image and the first background image of the first image, the first foreground image is displayed with the first animation effect, the first background image is displayed with the second animation effect, and the first image is displayed with a third animation effect.

18. The electronic device according to claim 11, wherein the performing effect processing on the first image to obtain a first video comprises:
in response to the presence of a plurality of first images, determining a plurality of image videos, each of the image videos corresponding to a respective one of the first images, and determining the first video based on the plurality of image videos.

19. The electronic device according to claim 11, wherein after the displaying the first video, the processor is further configured to:
in response to an effect editing trigger operation for the first video, display an effect editing item corresponding to the first video, wherein the effect editing item comprises at least one selected from the group consisting of an image content editing item and an image effect editing item; and
receive an editing operation for effect information of the first video via the effect editing item, and update the first video based on the editing operation for effect information.

20. A non-transitory storage medium, wherein the non-transitory storage medium comprises computer-executable instructions, the computer-executable instructions, when executed by a computer processor, causes an effect processing method to be performed, the effect processing method comprises:
obtaining a first image in response to an effect processing request, wherein the first image comprises a first foreground object; and
performing effect processing on the first image to obtain a first video and displaying the first video, wherein the first video comprises a first foreground image of the first image, the first foreground image comprises the first foreground object, and at least a part of an object area of the first foreground object is presented in a preset style.
